(19) United States
(12) Patent Application Publication
(10) Pub. No.: US 2012/0273521 A1
(43) Pub. Date: Nov. 1, 2012

(54) LIQUID DISPENSING AND SEALING STRUCTURE

(76) Inventor: Race WU, Taichung City (TW)

(21) Appl. No.: 13/096,605

(22) Filed: Apr. 28, 2011

(51) Int. Cl. B67D 7/08

(52) U.S. Cl. 222/153.14; 222/522; 222/525

(57) ABSTRACT

A liquid dispensing and sealing structure includes a dispensing unit having a liquid inlet and a liquid outlet communicated with the liquid inlet, and a blocking member having a fixation portion fixed to the dispensing unit, a blocking portion separatably blocking the liquid outlet of the dispensing unit, and at least one elastic deformable connection portion connected between the fixation portion and the blocking portion. Whether the liquid outlet is blocked for sealing or opened for dispensing the liquid from the liquid inlet is determined by a position of the blocking portion. In addition, the blocking portion is provided with an air permeable portion in communication with the liquid outlet, such that the ambient pressure and the inside pressure of a container connected with the liquid dispensing and sealing structure can be balanced.

### BACKGROUND OF THE INVENTION

1. Field of the Invention

The present invention relates generally to a liquid dispensing device and more particularly, to a liquid dispensing and sealing structure.

2. Description of the Related Art

Conventionally, the commercially available liquid dispensing devices, such as water bottles, are generally composed of a dispensing unit for opening the water bottle to facilitate dispensing or drinking of the bottle contents, such as water, beverage or other liquid, by squeezing or inclinedly tipping the water bottle. Providing that the dispensing unit is not switched from the on-condition to the off-condition after the dispensing unit is forced to the on-condition, as soon as the water bottle is tipped down or turned upside down, the bottle contents will soon flow out and the out-flowing liquid may wet the ambient things. On the other hand, the body of the water bottle may deform inwardly due to the unbalance of the inside pressure and outside pressure of the water bottle after the contained liquid is discharged out and the dispensing unit is switched to the off-condition. Because the configuration of the conventional dispensing unit may not allow air to flow back into the deformed water bottle, the depressed deformation of the bottle body may be unable to rebound to its original shape. Therefore, it is desired to develop a liquid dispensing and sealing structure for use with water bottles or other containers, which can improve the aforesaid drawbacks.

### SUMMARY OF THE INVENTION

The present invention has been accomplished in view of the above-noted circumstances. It is therefore one objective of the present invention to provide a liquid dispensing and sealing structure which can dispense or seal liquid easily and is convenient in operation for a user.

Another objective of the present invention is to provide a liquid dispensing and sealing structure, which can balance the inside and outside pressures of a container that is enclosed by the structure so as to allow the container to return to its initial shape after it is deformed due to the difference of inside and outside pressures of the container.

To achieve the above-mentioned objectives, a liquid dispensing and sealing structure, which is provided by the present invention and adapted to be connected to a contain or configured as a container, comprises a dispensing unit having a liquid inlet and a liquid outlet communicated with the liquid inlet, and a blocking member having a fixation portion fixed to the dispensing unit, a blocking portion separatably blocking the liquid outlet of the dispensing unit, and an elastic deformable connection portion connected between the fixation portion and the blocking portion.

When the dispensing unit is located at an open position, a pressing force or a suction force applying on the container by the user will drive the liquid in the container to flow to the liquid outlet of the dispensing unit through the liquid inlet of the dispensing unit to further push the blocking portion of the blocking member away from the liquid outlet, such that the liquid can be dispensed out of the liquid dispensing and sealing structure while the connection portion that is connected between the fixation portion and the blocking portion is kept at an elastic deformed manner. As soon as the aforesaid applying force is released, the blocking portion of the blocking member will return to its initial position due to the elastic rebound force of the connection portion to block the liquid outlet again. Under this circumstance, though the blocking member receives no external sealing force, the blocking member can completely seal the liquid around the liquid outlet or can block the liquid to an extent that only a little amount of liquid can possibly leak.

Preferably, the blocking portion of the blocking member is provided with an air permeable portion, such as a slit, communicated with the liquid outlet, such that ambient air can flow into the container through the slit of the blocking portion to balance the inside pressure with the external pressure of the container for enabling the deformed container, which is deformed due to the applying force of the user, to return to its original shape.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective assembled view of a liquid dispensing and sealing structure according to a preferred embodiment of the present invention;

FIG. 2 is another perspective view of the liquid dispensing and sealing structure of the preferred embodiment of the present invention;

FIG. 3 is an exploded view of the liquid dispensing and sealing structure of the preferred embodiment of the present invention;

FIG. 4 shows an exploded view of the liquid dispensing and sealing structure observed from another viewing angle;

FIG. 5 is a sectional view taken along line 5-5 of FIG. 1;

FIG. 6 is a sectional view taken along line 6-6 of FIG. 1;

FIG. 7 is similar to FIG. 5, but showing that the dispensing unit of the liquid dispensing and sealing structure is rested at an open position;

FIG. 8 is similar to FIG. 6, but showing that the dispensing unit of the liquid dispensing and sealing structure is rested at the open position and the liquid outlet of the dispensing unit is blocked by the blocking member, and

FIG. 9 is similar to FIG. 8, but showing that and the liquid outlet of the dispensing unit is not blocked by the blocking member.

### DETAILED DESCRIPTION OF THE INVENTION

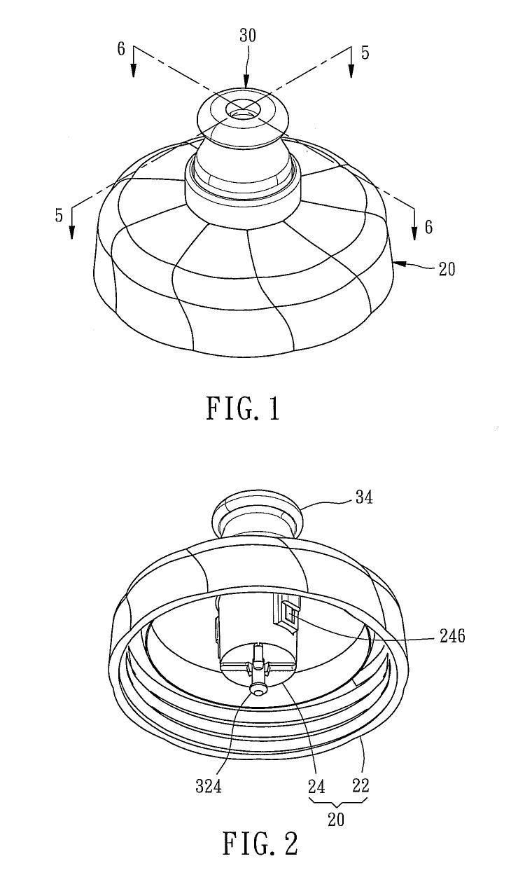

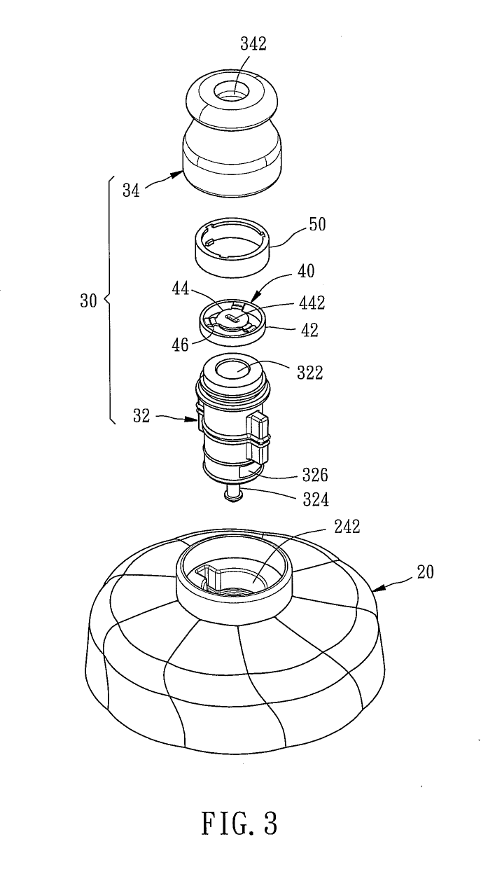

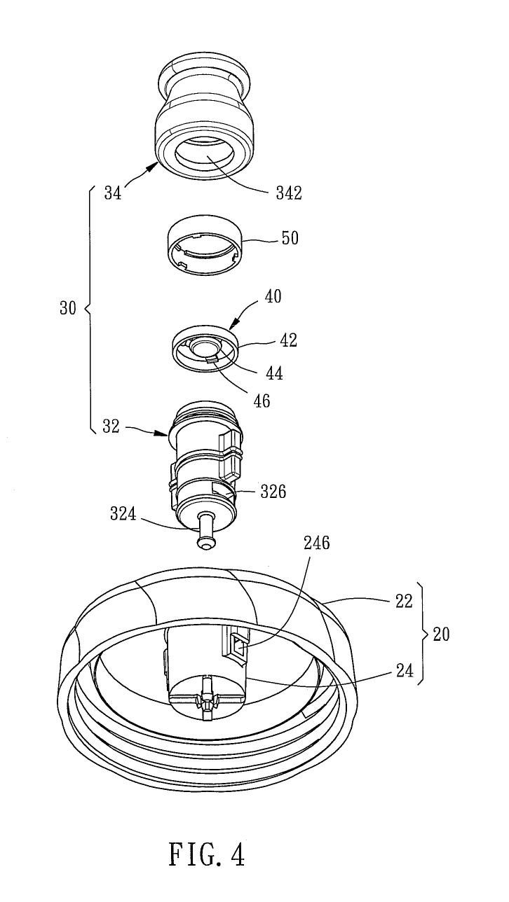

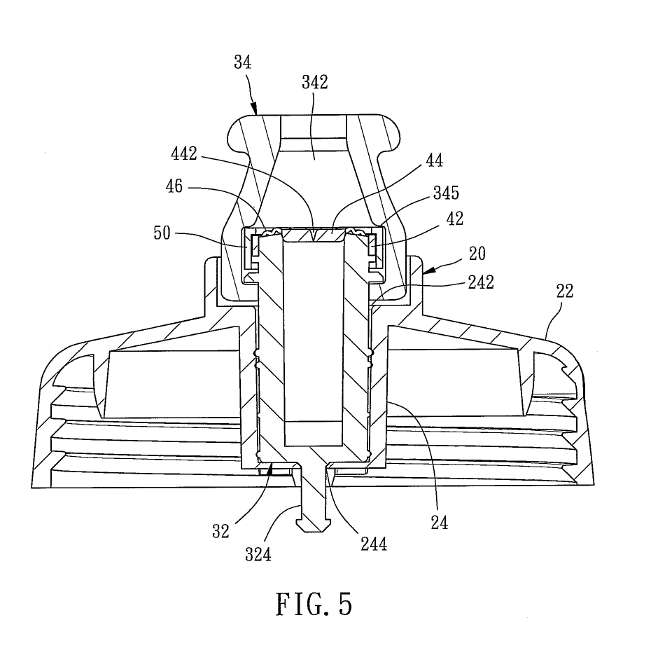

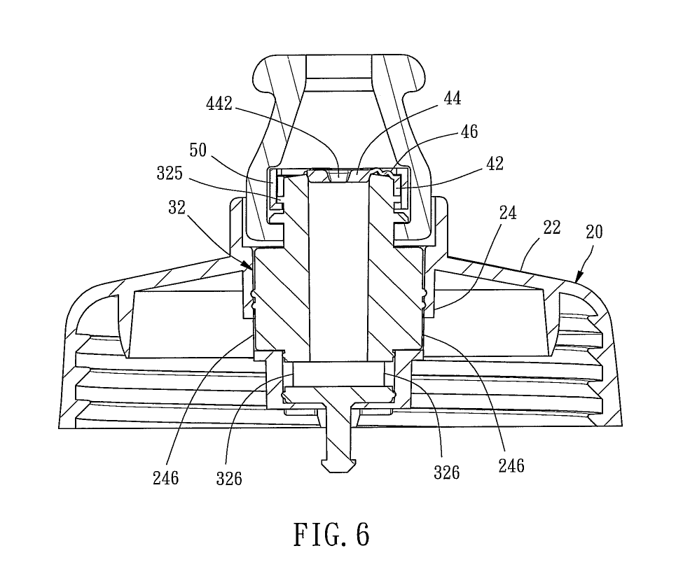

As shown in FIGS. 1-6, a liquid dispensing and sealing structure provided according to a preferred embodiment of the present invention is composed of a cap 20, a dispensing unit 30, a blocking member 40 and a positioning ring 50.

The cap 20 includes an engagement portion 22 for coupling a container (not shown in the drawings), and a receiving portion 24 extending downwardly from a center of the engagement portion 22 into an inside of the container. The receiving portion 24 is provided with a top opening 242, a bottom opening 244 opposite to the top opening 242, and two through holes 246 formed on the periphery wall and aligned in a line. The top opening 242 faces outside of the container and the bottom opening 244 and the through holes 246 are located inside the container.

It will be appreciated that the cap 20 can be generically defined as an installation unit. Broadly speaking, the installation unit may be a container. In other words, the liquid dispensing and sealing structure of the present invention comprises an installation unit including but not limited to a cap 20 or a container.

The dispensing unit 30 includes a liquid conduit member 32 and a suction mouth 34. The liquid conduit member 32 is shaped like a cylinder having an open top end terminating as a liquid outlet 322, a close bottom end with a protruded positioning rod 324, and two liquid inlets 326 provided at the peripheral wall thereof adjacent to the bottom end, opposite to each other and communicated with the liquid outlet 322. The suction mouth 34 is made from an elastically deformable material, such as silicon, and shaped like a tube having a passage 342. The suction mouth 34 is fixedly coupled at an end thereof with the top end of the liquid conduit member 32 in such a way that the liquid outlet 322 is located inside the passage 342 of the suction mouth 34. The liquid conduit member 32 of the dispensing unit 30 is installed inside the receiving portion 24 of the cap 20 in such a way that the suction mouth 34 extends out of the cap 20 and is exposed outside the container, and the positioning rod 324 passes through the bottom opening 244 of the receiving portion 24.

As mentioned above, the installation unit may be realized as the cap 20 or a container, such that the installation unit may, in other words, include the receiving portion 24 with the through holes 246. If it is this case, the dispensing unit 30 is installed inside the receiving portion 24 of the installation unit.

The blocking member 40 is made from an elastically deformable material, such as silicon, as an integral unity, which includes a ring-shaped fixation portion 42, a round disc-like blocking portion 44 with a slit 442 having a cross-section gradually narrowed from its top end toward its bottom end, and three waved connection portions 46. The inner ends of the connection portions 46 are equiangularly connected to the circumference of the blocking portion 44 and the outer ends of the connection portions 46 are connected to the inner circumference of the fixation portion 42, such that the blocking portion 44 is suspended at an imaginary center of the fixation portion 42.

It will be appreciated that the slit 442 of the blocking member 40 may be broadly defined as an air permeable portion. That is, the blocking member 40 has an air permeable portion communicated with the liquid outlet 322.

The positioning ring 50 is capped on the outer periphery of the fixation portion 42 of the blocking member 40 for enabling the fixation portion 42 to be fixedly capped on the top portion of the liquid conduit member 32 in such a way that the blocking portion 44 is plugged into the liquid outlet 322 of the liquid conduit member 32 and the slit 442 of the blocking portion 44 is communicated with the liquid outlet 322. That is, the liquid dispensing and sealing structure of the present invention further comprises a positioning ring 50 that is capped on the fixation portion 42 of the blocking member 40 to fix the blocking member 40 to the dispensing unit 30.

In addition, the liquid conduit member 32 and suction mouth 34 of the dispensing unit 30 are respectively provided with various retaining portions 325 and 345 to hold the positioning ring 50 so as to further secure the positioning ring 50 and the blocking member 40 to the liquid conduit member 32.

In the light of the above, the liquid dispensing and sealing structure of the present invention may, by all accounts, comprise a dispensing unit 30 and a blocking member 40 at the very least.

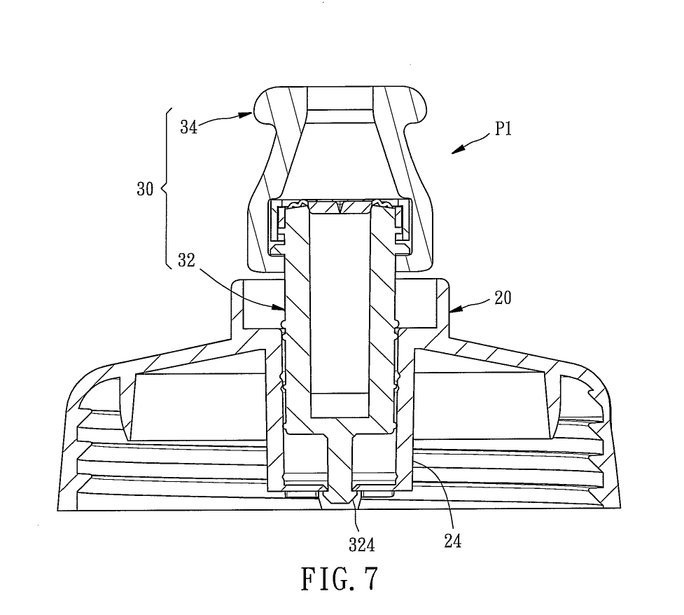

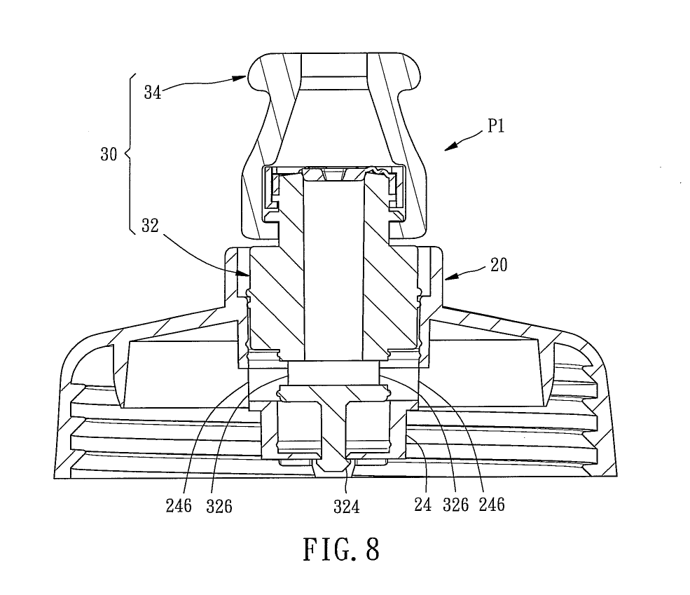

To use the liquid dispensing and sealing structure, the suction mouth 34 needs to be pulled outwardly. Along with the outward movement of the suction mouth 34, the dispensing unit 30 will linearly move relative to the cap 20 until the positioning rod 324 is stopped at the bottom end of the receiving portion 24 of the cap 20, as shown in FIGS. 7 and 8, such that the dispensing unit 30 will be located at an open position P1 where the liquid inlets 326 are respectively communicated with the through holes 246. That is, the dispensing unit 30, in general speaking, is installed in the installation unit having at least a through hole 246. The dispensing unit 30 can move relative to the installation unit to an open position where the liquid inlet 326 is communicated with the through hole 246 of the installation unit.

At this moment, the blocking portion 44 of the blocking unit 40 is still plugged into the liquid outlet 322. Because the slit 442 is small in size, the blocking portion can still maintain the sealing effect and block any foreign object. In other words, the blocking member 40 can block the liquid or gas entering the liquid inlet 326 from leak from the liquid outlet 322 or allow only a minus amount of leakage of the aforesaid liquid or air when no external force applies on the blocking member 40.

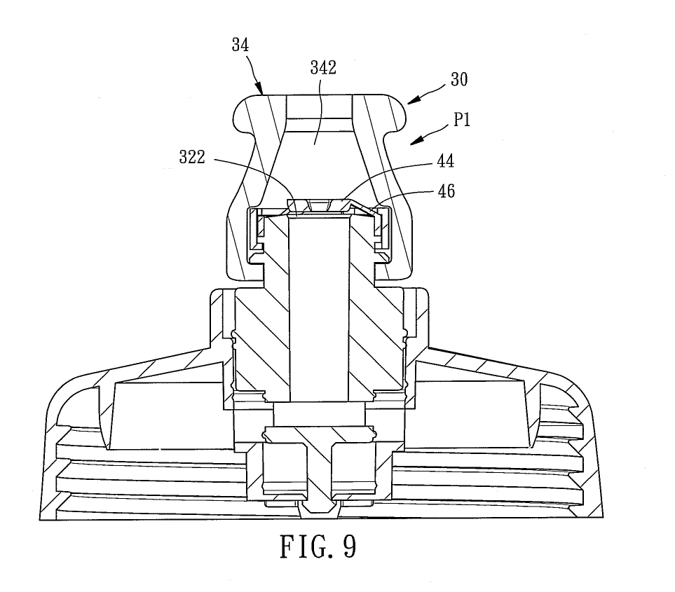

Thereafter, if the user wants to dispense or drink the liquid in the container, the user can squeeze the container, a deformable plastic bottle for example, or do a suction motion with his/her mouth by using the suction mouth 34 to cause a pressure difference between inside and outside of the container for enabling the liquid or gas to flow through the through holes 246 and the liquid inlets 326 to the liquid outlet 322 of the liquid conduit member 32 to push the blocking portion 44 of the blocking member 40 away from the liquid outlet 322, as shown in FIG. 9, in a way that the connection portions 46 that are connected with the blocking portion 44 are elastically deformed. As a result, a great amount of liquid can flow out of the liquid outlet 322 and then flow out of the liquid dispensing and sealing structure through the passage 342 of the suction mouth 34.

As soon as the user stops squeezing or sucking the container, because the blocking portion 44 no longer receives the pushing force from the liquid or the suction force from the user's mouth, the blocking portion 44 of the blocking member 40 will return to its initial position due to the elastic rebound force of the connection portions 46 to block the liquid outlet 322 again. In the meantime, since the air outside the container can still enter into the container through the slit 442 of the blocking portion 44 to balance the inside pressure with the outside pressure of the container, the container, if it is deformed, can return to its original shape quickly.

In addition to the preferred embodiment disclosed above, various modifications and/or alternate forms for the liquid dispensing and sealing structure of the present invention can be used as follows.

For example, the connection portions 46 of the blocking member 40 are not limited to be disposed on the liquid conduit member 32; alternatively, they can be disposed inside the liquid conduit member 32 to block the liquid outlet 322 of the liquid conduit member 32.

In addition, the positioning ring 50 can be eliminated, provided that the blocking member 40 has a portion for positioning.

Further, the dispensing unit 30 is not limited to be moveable between the open position and the close position; alternately, the dispensing unit 30 can be designed to be stationary.

Furthermore, the dispensing unit 30 is not limited to be composed of two individual elements, i.e. the liquid conduit member 32 and the suction mouth 34. The liquid conduit member 32 and the suction mouth 34 can be integrally formed as a signal unity.

Besides, the installation unit is not limited to be a cap-like configuration as the above-disclosed cap 20. In practice, the container itself or the opening structure of the container can be designed having the same configuration of the aforesaid cap 20.

Moreover, the installation unit and the dispensing unit are not limited to be two individual units assembled together. They can however be formed as a single unity; that is, the dispensing unit 30 may be installed in the container or become a part of the container.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A liquid dispensing and sealing structure, comprising:
a dispensing unit having a liquid inlet and a liquid outlet communicated with the liquid inlet; and
a blocking member having a fixation portion fixed to the dispensing unit, a blocking portion separatably blocking the liquid outlet of the dispensing unit, and an elastic deformable connection portion connected between the fixation portion and the blocking portion.

2. The liquid dispensing and sealing structure as claimed in claimed 1, further comprising an installation unit which comprises a cap or a container communicated with the dispensing unit.

3. The liquid dispensing and sealing structure as claimed in claim 2, wherein the dispensing unit is disposed in the installation unit; the installation unit is provided with a through hole; the dispensing unit is moveable relative to the installation unit to an open position where the liquid inlet is communicated with the through hole of the installation unit.

4. The liquid dispensing and sealing structure as claimed in claim 2, wherein the installation unit has a receiving portion with a through hole and the dispensing unit is disposed in the receiving portion of the installation unit.

5. The liquid dispensing and sealing structure as claimed in claim 2, wherein the dispensing unit comprises a liquid conduit member provided with the liquid inlet and the liquid outlet, and a suction mouth connected with the liquid conduit member.

6. The liquid dispensing and sealing structure as claimed in claim 2, wherein the fixation portion of the blocking member has a ring shape; the blocking portion is located a center of the fixation portion; a plurality of said connection portions are connected between the blocking portion and the fixation portion.

7. The liquid dispensing and sealing structure as claimed in claim 2, wherein the blocking portion of the blocking member is provided with an air permeable portion.

8. The liquid dispensing and sealing structure as claimed in claim 2, further comprising a positioning ring capped on the fixation portion of the blocking member for fixing the blocking member to the dispensing unit.

9. The liquid dispensing and sealing structure as claimed in claim 1, wherein the dispensing unit comprises a liquid conduit member provided with the liquid inlet and the liquid outlet, and a suction mouth connected with the liquid conduit member.

10. The liquid dispensing and sealing structure as claimed in claim 9, wherein the fixation portion of the blocking member has a ring shape; the blocking portion is located a center of the fixation portion; a plurality of said connection portions are connected between the blocking portion and the fixation portion.

11. The liquid dispensing and sealing structure as claimed in claim 9, wherein the blocking portion of the blocking member is provided with an air permeable portion.

12. The liquid dispensing and sealing structure as claimed in claim 9, further comprising a positioning ring capped on the fixation portion of the blocking member for fixing the blocking member to the dispensing unit.

13. The liquid dispensing and sealing structure as claimed in claim 1, wherein the fixation portion of the blocking member has a ring shape; the blocking portion is located a center of the fixation portion; a plurality of said connection portions are connected between the blocking portion and the fixation portion.

14. The liquid dispensing and sealing structure as claimed in claim 13, wherein the blocking portion of the blocking member is provided with an air permeable portion.

15. The liquid dispensing and sealing structure as claimed in claim 13, further comprising a positioning ring capped on the fixation portion of the blocking member for fixing the blocking member to the dispensing unit.

16. The liquid dispensing and sealing structure as claimed in claim 1, wherein the connection portion of the blocking member has a waved shape.

17. The liquid dispensing and sealing structure as claimed in claim 1, wherein the blocking portion of the blocking member is provided with an air permeable portion.

18. The liquid dispensing and sealing structure as claimed in claim 17, wherein the air permeable portion is a slit.

19. The liquid dispensing and sealing structure as claimed in claim 17, further comprising a positioning ring capped on the fixation portion of the blocking member for fixing the blocking member to the dispensing unit.

20. The liquid dispensing and sealing structure as claimed in claim 1, further comprising a positioning ring capped on the fixation portion of the blocking member for fixing the blocking member to the dispensing unit.
